(19) United States
(12) Patent Application Publication
(10) Pub. No.: US 2026/0050577 A1
(43) Pub. Date: Feb. 19, 2026

(54) SYSTEM AND METHODS FOR MANAGING UPLOADED DOCUMENTS AND EXISTING DOCUMENTS

(71) Applicant: Kyocera Document Solutions Inc., Osaka (JP)

(72) Inventors: Selim ZAMAN, San Mateo, CA (US); Chikara Yuki, Walnut Creek, CA (US)

(73) Assignee: Kyocera Document Solutions Inc., Osaka (JP)

(21) Appl. No.: 18/808,793

(22) Filed: Aug. 19, 2024

(51) Int. Cl. G06F 16/16; G06F 16/174

(52) U.S. Cl. CPC G06F 16/162; G06F 16/1748

(57) ABSTRACT

A document management method for categorizing uploaded documents from a legacy system and re-organizing existing documents saved in a documents management system is disclosed. The method categorizes the uploaded documents and existing documents based on metadata embedded therein and saves the uploaded documents and existing documents in a plurality of category folders. The method further generates new category folders and detects and deletes duplicated documents in the uploaded documents and existing documents. A document management system for categorizing uploaded documents from a legacy system and re-organizing existing documents saved in a documents management system is also disclosed.

### FIELD OF THE INVENTION

The present invention relates to a system and method for managing and organizing uploaded documents. In particular, the present invention relates to a system and method for uploading bulk documents to a new document management system and re-organizing existing documents saved in the new document management system.

### DESCRIPTION OF THE RELATED ART

When a new customer merges their document management system into a new system, the customer usually needs to import documents in bulk into this new system. Currently, after the documents are uploaded, the customer has to manually organize their folder structures so that the uploaded documents can be saved in their specific folders. This approach, however, is time-consuming.

Therefore, the present invention aims at improving the efficiency and accuracy of categorizing and saving uploaded documents. Currently, there are no document managing systems and methods that can categorizes documents into folders automatically.

### SUMMARY OF THE INVENTION

A computer-implemented method for importing bulk documents from a legacy system to a new system is disclosed. The method for importing bulk documents includes uploading a plurality of documents into a new document management system, categorizing the plurality of documents based on metadata embedded in the plurality of documents, storing the plurality of documents to their respective category folders based on the categories of the plurality of documents, and if no suitable folders are found for certain documents among the plurality of documents, generating new folders for saving the certain documents.

The metadata embedded in the plurality of documents include information regarding titles, authors, generating dates, classes, and attributes of the documents. The category folders are generated based on a categorization map that is created based on existing folder structures, and a standard business folder structure.

The method for importing bulk documents in accordance with the disclosed embodiments further includes revising the category map or creating a new categorization map if the categorization map is not sufficient to categorize the plurality of documents. Further, if certain document of the plurality of uploaded documents cannot be categorized, the computer-implemented method further comprises placing certain documents in a miscellaneous folder, analyzing contents of the certain documents to obtain keywords of the certain documents, searching same keywords from a configurable look-up file, and categorizing the certain documents based on the same keywords found in the configurable look-up file.

The method for importing bulk documents further comprises detecting and deleting duplicated documents while uploading the plurality of documents. The method detects that two or more documents among the plurality of documents has same metadata, compares contents of the two or more documents to determine if the contents of the two or more documents are exactly the same, reserves one document from the two or more documents, and marks a remaining of the two or more documents other than the reserved one document as “Deleted.” The remaining of the two or more documents marked as “Deleted” are deleted after all of the plurality of documents are uploaded, categorized, and stored in the multiple folders.

A computer-implemented method for organizing new importing documents and existing documents saved in a document management system is also disclosed. The method includes uploading a plurality of documents, categorizing the uploaded plurality of documents and the existing documents based on metadata embedded in the uploaded plurality of documents and the existing documents, reorganizing existing folders of the document managing system, each of the existing folder corresponding to a category of the uploaded plurality of documents and the existing documents, and storing the uploaded plurality of documents and the existing documents to the reorganized folders based on categories of the uploaded plurality of documents and the existing documents. In the method, reorganizing the existing folder includes revising the existing folders, and/or creating new folders based on information stored in the metadata. Further, the information stored in the metadata includes titles, authors, generating dates, classes and attributes of the uploaded plurality of documents and the existing documents.

The above method further includes determining if there are duplicate documents among the uploaded plurality of documents and the existing documents, reserving one document among the duplicated documents, and marking a remaining of the duplicated documents as “Deleted,” and deleting the remaining of the duplicated documents after all of the uploaded plurality of documents and the existing documents are saved.

According to the disclosed method, determining duplicated documents includes: detecting two or more documents among the uploaded plurality of documents and the existing documents having same metadata, comparing contents of the two or more documents, and if the contents of the two or more documents are exactly the same, reserving the one document of the two or more documents and marking the remaining of the two or more documents as “Deleted.”

The method further places certain documents of the uploaded plurality of documents and the existing documents in a miscellaneous folder if the certain document cannot be categorized, analyzes contents of the certain documents to obtain keywords of the certain documents, searches same keywords from a configurable look-up file, and categorizes the certain documents based on the same keywords found in the configurable look-up file.

A document management system for organizing imported bulk documents is further disclosed. The system includes a database for storing medium-readable instructions, a managing device, comprising a processor, wherein the medium-readable instructions stored in the database, when executed, causes the processor to upload the bulk documents into the document management system, wherein the bulk documents are migrating from a legacy document management system, categorize the bulk documents based on metadata embedded in the bulk documents, generate multiple folders, each corresponding to a category of the bulk documents, and store the bulk documents to the multiple folders based on the categories of the bulk documents. The document management system further includes a storage for storing the multiple folders.

The processor of the above system is further configured to create a categorization map based on results of the categorizing step, in which the categorization map includes structures of the multiple folders, document classes, and attributes, and the categorization map is used for categorizing new incoming documents.

The processor is also configured to place certain documents in a miscellaneous folder if the certain document cannot be categorized, analyze contents of the certain documents to obtain keywords of the certain documents, search same keywords from a configurable look-up file, and categorize the certain documents based on the same keywords found in the configurable look-up file.

The processor is further configured to detect that two or more documents among the bulk documents has same metadata, compare contents of the two or more documents to determine if the contents of the two or more documents are exactly the same, reserve one document from the two or more documents, and mark a remaining of the two or more documents as “Deleted,” and delete the remaining of the two or more documents marked as “Deleted” after all of the bulk documents are uploaded, categorized, and stored in the multiple folders.

### BRIEF DESCRIPTION OF THE DRAWINGS

Various other features and attendant advantages of the present invention will be more fully appreciated when considered in conjunction with the accompanying drawings.

FIG. 1 depicts a block diagram of a document management system according to the disclosed embodiments.

FIG. 2 illustrates an OCR device according to the disclosed embodiments.

FIG. 3 depicts a flowchart for categorizing bulk imported documents in accordance with the disclosed embodiments.

FIG. 4 depicts a flowchart for generating new categories and new category folders in accordance with the disclosed embodiments.

FIG. 5 depicts a flowchart for cleaning up duplicated documents in accordance with the disclosed embodiments.

FIG. 6 depicts a flowchart for reorganizing uploaded documents and existing documents for an existing customer in accordance with the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings.

Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a processing module within a document management system to pre-process uploaded bulk documents before saving them into a database. These pre-processing systems and methods are capable of categorizing the documents during the uploading process based on detected metadata embedded in the documents and saving them to specific category folders. The disclosed embodiments generate folders based on metadata of the documents, and save the documents to their respective folders. The categorization can be done automatically, thereby the importing time and efficiently for bulk documents can be greatly reduced.

In accordance with the disclosed embodiments, a standard folder categorization map may be provided in the document managing system. The standard folder categorization map is created based on commonly used categorized folders, such as invoices, contract, personal record, finance, and so on. Based on the standard folder categorization map, the documents are saved in their respective folders according to their metadata. The standard folder categorization map can be a built-in map of the document managing system. In case that the categorized folders in the standard folder categorization map do not cover all categories of the imported documents, an administrator user of the document management system may manually amend the standard folder categorizing map, or generate a new folder categorizing map for saving the imported documents.

During the document-importing process, the system also looks for duplicate documents based on the document metadata. The document metadata may include company name, issue date, author name, etc. The document metadata may also include document classes such as invoice, contract, receipts, personal record, student record, patient record, etc., and attributes such as invoice No., contract ID, student name, student ID, patent name, patient ID, and so on. When two documents with same metadata, same document classes, and same attributes are detected, the disclosed embodiments may compare the contents of the two documents to determine if the two documents are indeed duplicate. If they are duplicate, one of the documents will be marked “to-be-delete” and will be deleted at a last step of document-importing process.

The disclosed embodiments are further suited for cleaning up saved documents in the folders or updating the folder structures for existing customers or users when the database grows too big in size or when the document metadata have changed that requires a re-organization of the saved documents. The disclosed embodiments may clean up saved documents periodically or in demand and based on the document metadata may detect duplicated documents and delete them. Details of the re-organizing the saved documents for existing customers and the deletion of the duplicate documents will be described in more detail below.

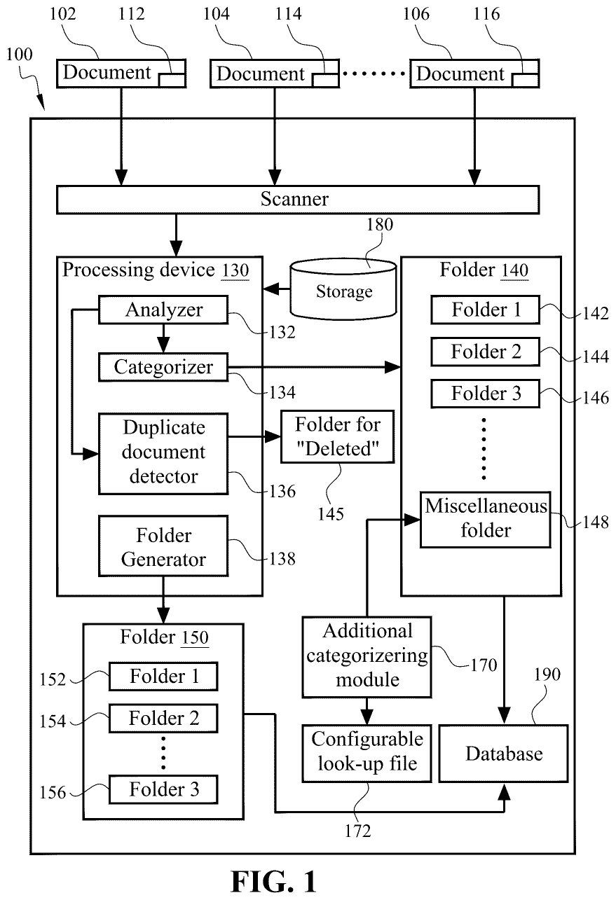

FIG. 1 illustrates a schematic diagram of a document management system 100 in accordance with the disclosed embodiments. The disclosed embodiments aim to efficiently categorize bulk documents when being imported from an old system to a new document management system, such as system 100, before they are stored in system 100. The categorization of the documents is determined from metadata embedded in the documents.

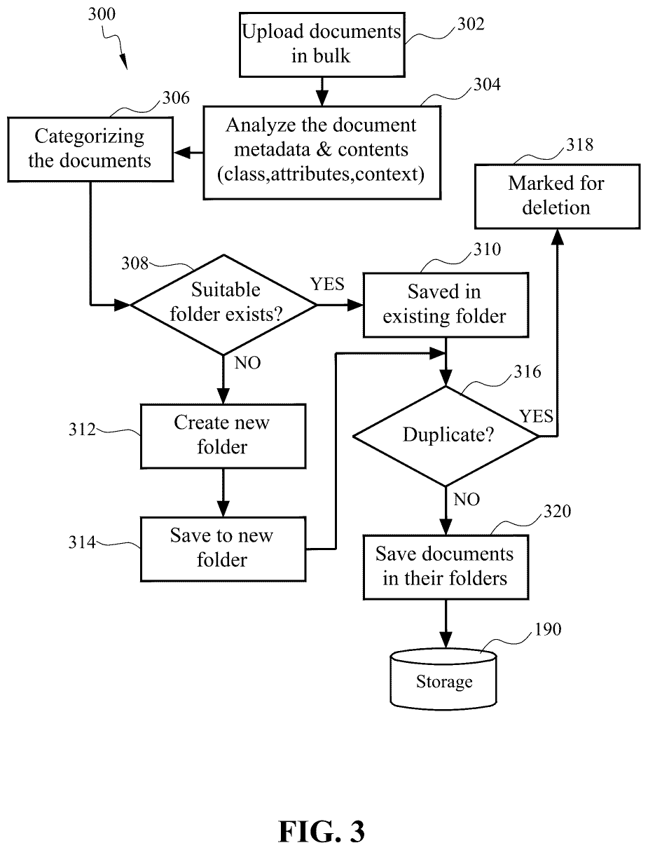

The metadata may include titles, dates, types, creators, classes, attributes, etc. of the documents. The disclosed embodiments designate the categories of the documents based on their metadata and save the documents to their respective category folders before storing them to a system database. The category folders may be pre-determined or customized-generated. Details of generating the category folders will be described below with reference to FIG. 3.

As illustrated in FIG. 1, system 100 includes a scanning device 120, a processing device 130, a plurality of folders 140 and 150, a storage 180, and database 190. Storage 180 stores medium-readable instructions, that when executed, cause processing device 130 to perform a number of functions, such as analyzing metadata embedded in a plurality of documents uploaded during an importing process and existing documents saved in system 100, categorizing these documents based on the analyzing results, and so on. Great details regarding these functions will be described in the following FIGS. 3-6.

A plurality of documents, such as documents 102, 104, and 106 as an example, are imported into document management system 100 of the disclosed embodiments. Documents 102, 104, and 106 may be electronic documents, each of which is embedded with metadata 112, 114, and 116 when it is generated. Metadata 112, 114, and 116 may include titles, classes, dates, authors, attributes, keywords, etc. of documents 102, 104, and 106. In the disclosed embodiments, only three documents and four folders are shown for illustrative purpose. The numbers of the imported documents and folders are not limited thereto.

During the bulk importing process, scanning device 120 scans documents 102, 104, and 106 for their metadata. Detected metadata 112, 114, and 116 will be sent to processing device 130. Processing device 130 analyzes them and categorizes documents 102, 104, and 106 based on their metadata, and saves them into appropriate folders 140. Folders 140 may be pre-generated in system 100 based on a standard folder categorization map, which includes commonly-used folders, such as invoices, contracts, personal records, finance, etc., i.e., folders that are generally existed in a typical business organization. System 100 may also generate a new or revised folder categorization map based on the document classes, attributes, and keywords or based on document categories generally resided in a new customer's business organization.

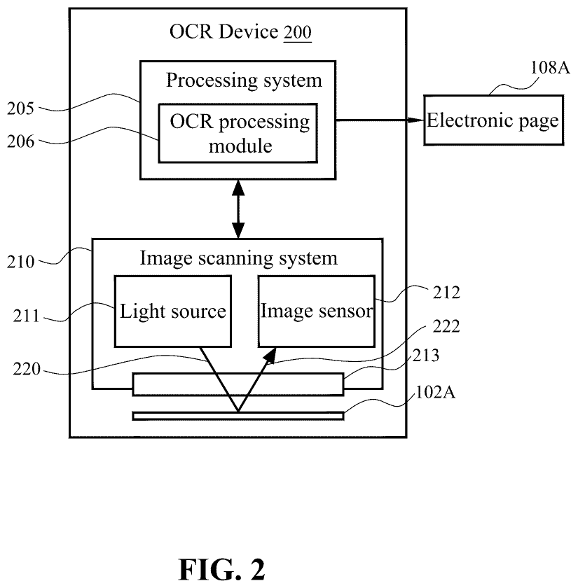

Scanning device 120 may be a scanner for scanning documents 102, 104, and 106, and for detecting metadata 112, 114, and 116 of documents 102, 104, and 106. In some embodiments, scanning device 120 may be an OCR (Optical Character Recognition) device that scans and performs an OCR operation on documents 102, 104, and 106. In addition to perform the OCR operation on the documents, the OCR device may further detect metadata embedded in the documents or embeds metadata on the documents based on contents or keywords contained in the documents. The OCR device will be described in more details in FIG. 2.

Metadata 112, 114, and 116 after detected by scanning device 120 are sent to processing device 130 for processing. Processing device 130 includes an analyzer 132 and categorizer 134. Analyzer 132 analyzes the document class, attributes, keywords contained in metadata 112, 114, and 116, and categorizer 134 determines the categories of these documents and saves documents 102, 104, and 106 to their respective folders 140. Folder 140 includes a plurality of folders, each of which is designated with a category. Not all the imported documents can be clearly categorized. Those that cannot be easily be categorized will be placed in a miscellaneous folder 148 for manual categorization by an administrator or user.

As described above, system 100 may include standard folders, such as folders 142, 144, and 146, which are preset based on categories normally existed in a standard business organization. However, when a new customer's organization has a different business structure and the standard folders are not suitable for this organization's business structure, processing device 130 further includes a folder generator 138 for revising folders 142, 144, and 146 to match the new customer's organization structure. Folder generator 138 may also generate a customized categorization map to create new set of folders 150, such as folders 152, 154, and 156. This may involve human's intervention, i.e., an administrator of the new customer's organization may interact with folder generator 138 to manually create the customized categorization map and the set of folders 150. In either case, processing device 130 stores documents 102, 104, and 106 will in their respective folders based on results received from analyzer 132 and categorizer 134.

System 100 further includes a categorizing module 170 for categorizing the documents saved in miscellaneous folder 148. As described above, miscellaneous folder 148 stores the documents, of which the embedded metadata (i.e., document title, document class, attributes, keyword etc.) are inconclusive for analyzer 132 and categorizer 134 to find a folder for these documents. Categorizing module 170 is used to perform a contextualization operation by scanning and retrieving keywords contained in these documents and looking for the same keywords from a configurable look-up file 172 to make determinations of best folders for placing these documents. The keywords saved in configurable look-up file 172 is configurable by users, such as the administrators. In accordance with the disclosed embodiments, categorizing module 170 may be a software module separated from processing device 130. Categorizing module 170 may also be a part of processing device 130. There is no limitation in this regard.

After all the imported documents are categorized and saved in their respective folders, folders 140 and 150 will be saved in database 190.

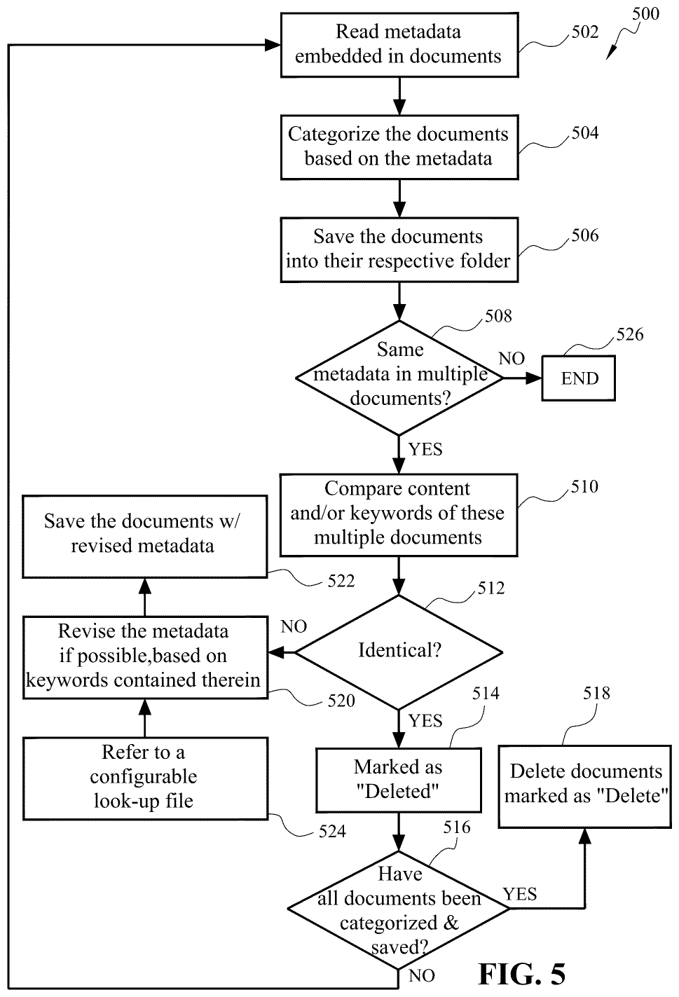

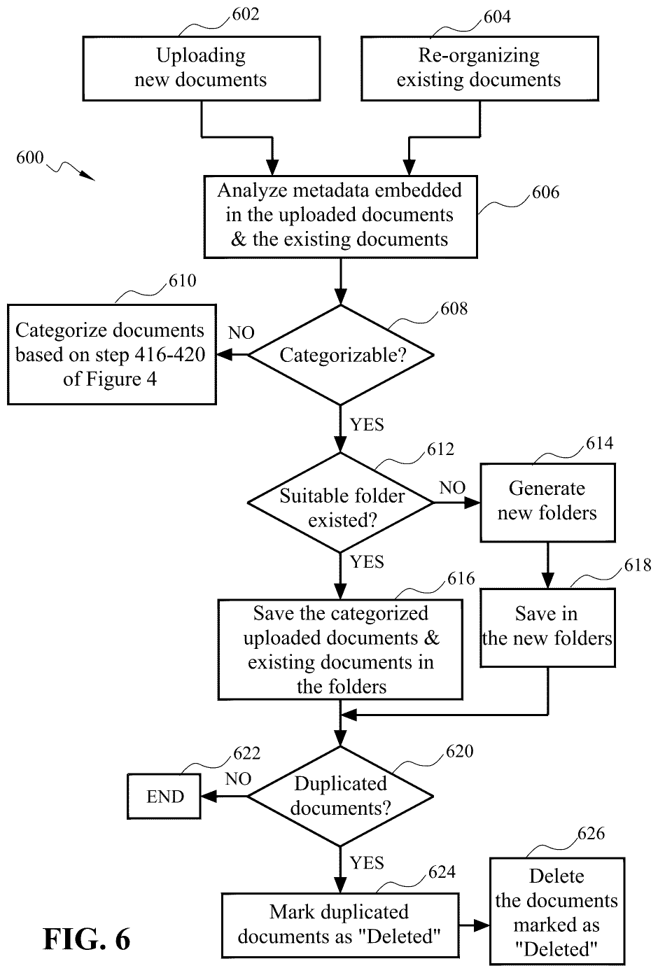

Based on the metadata, the disclosed embodiments are also capable of detecting duplicate documents among the imported bulk documents. In accordance with the disclosed embodiments, when detecting two or more than two documents that have a same metadata, same document class, and same attributes, duplicate document detector 136 would compare contents of these documents to determine whether these documents are exactly the same. If these documents are exactly the same, they are considered “duplicated.” In this case, only one document will be saved in a folder without marking, but the duplicated document(s) will either be saved in a same folder with marking “deleted” or saved in a folder 145 for deletion. In the disclosed embodiments, the documents marked as “deleted” will be deleted after all documents are imported into system 100 as a final step of the bulk document import process. In the final step, processing device 130 deletes all the documents that are marked as “deleted.”The detection and deletion of duplicated documents are not only limited to clean up new imported documents as described-above, but also are applicable for cleaning up duplicated documents and re-organizing documents for exiting customers. That is, when a folder structure of an existing customer has grown too big in size or the metadata embedded in their documents are changed or updated, system 100 may clean up duplicated documents, and re-categorize their documents based on the updated metadata. In alternative embodiments, system 100 may alter the metadata of the documents according to requests received from the customers and may update the category folders accordingly. Details of cleaning up and updating folders in accordance with the disclosed embodiments will be described below with reference to FIGS. 5 and 6.

FIG. 2 depicts a schematic diagram of an OCR device 200 that can be used in the disclosed embodiment as scanning device 120 for scanning scan documents 102, 104, and 106. OCR device 200 performs OCR operations on documents 102, 104, and 106 and is capable of detecting metadata embedded in documents 102, 104, and 106. Normally when performing the OCR operation, OCR device 200 receives a page or document 102A of first electronic document 102. Further pages may be loaded after processing of page 102A is complete. OCR device 200 includes an image scanning system 210 communicatively coupled to a processing system 205 via a communications link 207. Communications link 207 may be a wire, a communications cable, a wireless link, or a metal track on a printed circuit board.

Image scanning system 210 includes a light source 211 that projects light 220 through a transparent window 213 to strike a surface of page 102A. Page 102A, which may be a sheet of paper containing text or graphics, reflects light 220 towards an image sensor 212.

Image sensor 212 contains light sensing elements, such as photodiodes or photocells, converts received light 222 into electrical signals that are transmitted to OCR processing module 206 within processing system 205. The electrical signals may be digital bits.

Processing system 205 generates electronic page 108A from the captured data for page 102A. Electronic page 108A is included in one of the electronic documents within first electronic document 102. In some embodiments, OCR device 200 is a slot scanner incorporating a linear array of photocells. OCR processing module 206 that is a part of processing system 205 may be used to operate upon the electrical signals for performing optical character recognition of text and graphics printed on page 102A.

FIG. 3 depicts a process 300 for categorizing bulk imported documents in accordance with the disclosed embodiments. In the disclosed embodiments, to simplify a bulk document importing process, the documents are categorized and saved in their respective category folders. Therefore, the categorizing process is done in a pre-process step of the bulk document importing process before the bulk documents are saved into a database.

Step 302 executes by importing documents in bulk into system 100 of FIG. 1 of the disclosed embodiments. As described in FIG. 1, scanning device 120 first scans the documents to detect metadata, such as metadata 112, 114, and 116 of the documents, such as documents 102, 104, and 106.

Step 304 executes by analyzing the document metadata and/or document classes, to determine categories of the documents. Metadata stores information about document's title, author, keywords, class, attributes, and so on.

Next, step 306 executes by categorizing the documents based on the metadata analyzed at step 304.

Step 308 executed by determining whether there are suitable category folders for the documents. If the answer is YES, step 310 executes by saving the documents to existing category folders. If the answer is NO, step 312 executes by revising the existing category folders or generating new category map and corresponding category folders at step 314 executes by saving the documents to the new category folders.

Further, step 316 executes by determining whether there are duplicated documents in the imported documents. Determination of duplicated documents is based on metadata and contents of the documents. If there are duplicated documents, step 318 executes by marking the duplicated documents with “deleted”. If no duplicated documents exist, step 320 executes by saving the documents in their respective category folders. A process for determining duplicated documents in accordance with the disclosed embodiments will be described in FIG. 6. For brevity, the process for determining duplicated documents is omitted here.

After all documents are imported and saved in the folders, all the folders are further saved in storage, such as storage 190 of FIG. 1.

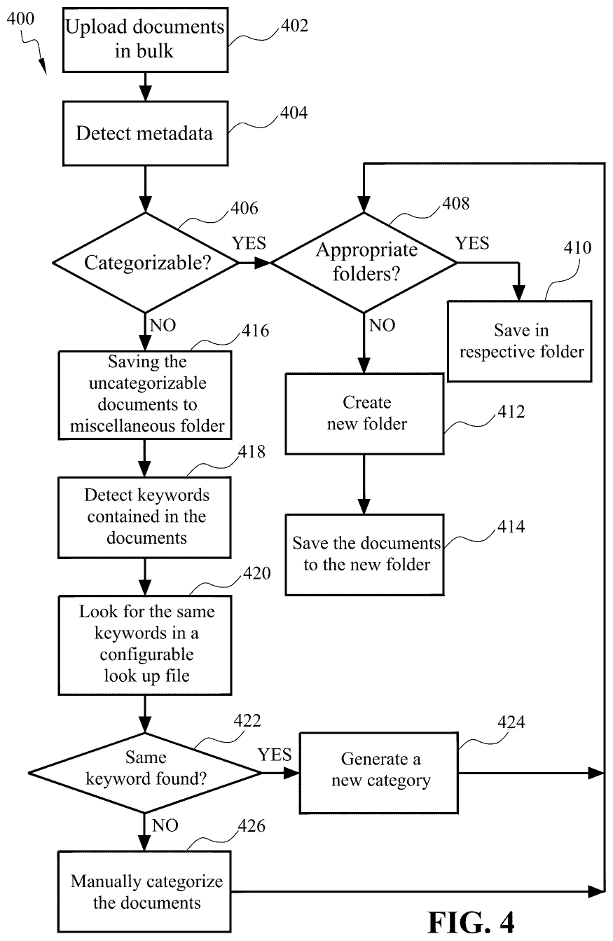

FIG. 4 depicts a process 400 for generating new categories and new category folders in accordance with the disclosed embodiments.

Step 402 executes by importing bulk documents to system 100.

Step 404 executes by detecting the metadata embedded in the imported documents. As described above, the metadata are detected during a scanning device, such as scanning device 120 of FIG. 1 or an OCR device 200 of FIG. 2.

Based on the information stored in the metadata, step 406 executes by determining whether a document can be categorized. If the answer is Yes, then step 408 executes by determining whether there are appropriate category folders existed in system 100. If a category folder is already existed in system 100 for this particular document, step 410 executes by saving the document to the category folder.

If the answer of step 408 is NO, i.e., no appropriate folder can be used to save the document, step 412 executes by creating a new folder for this document. The new folder may be created with human's intervention. For example, an administrator may create the new folder with a category name corresponding to this document through a user interface. In an alternative embodiment, the administrator may generate a customized category map for a new customer according to a structure of the new customer's business organization. In either case, after new folder is created at step 412, step 414 executes by saving this document to the new folder.

In some cases, the information saved in the metadata of the document are not clear enough for categorizer 134 to categorize the document. That is, the answer for step 406 is NO. Therefore, step 416 executes by saving uncategorizable documents to a miscellaneous folder, such as folder 148 of FIG. 1. Next, step 418 executes by scanning and detecting a keyword contained in a uncategorizable document saved in the miscellaneous folder 148, and step 420 executes by looking for the same keyword in a configurable look-up file. Step 418 may be executed by using additional categorizing module 170 of FIG. 1. The configurable look-up file mentioned at step 420 may be configurable look-up file 172 of FIG. 1. Configurable look-up file 172 stores a plurality of keywords and a plurality of categories corresponding to the plurality of keywords.

At step 422, if the same keyword is found in the configuration look-up file (i.e., Yes at step 422,) process 400 proceeds to generate a new category that corresponds to a category defined in the configuration look-up file for this keyword. Next, step 424 executes by saving the uncategorizable document to the new category.

However, if at step 422, the same keyword is not found in the configuration look-up file (i.e. NO at step 422,) process 400 proceeds to step 426. Step 426 executes by manually categorizing the uncategorizable document, generating a new category folder, and saving the uncategorizable document to the new category folder. Step 426 may be performed by the administrator of system 100, and may be similar to steps 412-414.

FIG. 5 further depicts a process 500 for cleaning up duplicated documents in accordance with the disclosed embodiments. Process 500 may be used for deleting duplicated documents among new imported documents. Process 500 may also be used for cleaning up duplicated documents and re-organizing documents for an existing customer.

Process 500 starts at step 502 that executes by detecting and analyzing metadata embedded in imported bulk documents or embedded in a plurality of existing documents.

Step 504 executes by categorizing the documents based on their embedded metadata, and step 506 executes by saving the documents into their respective category folders. As described before, system 100 may not have suitable category folders for every document, or system 100 is not able to categorize the documents. In this case, process 500 may include creating new category folders and/or creating new categories, as described in FIGS. 3 and 4. As process 500 mainly focuses on detecting and deleting duplicated documents, those steps are omitted here for brevity.

Step 508 executes by determining whether same metadata are found in multiple documents. Same metadata means that the document title, document author, document date, the document class, and the document attributes included in the metadata are all the same. If no same metadata are found (i.e., NO,) process 500 goes to step 526 for an end. However, if same metadata are found in multiple documents (i.e., YES,) process 500 goes to step 510, wherein the contents and keywords of these multiple documents are compared.

Step 512 executes by determining if the contents of these multiple documents are identical. If they are identical (i.e., YES,) step 514 executes by marking duplicated documents as “deleted” except one to be reserved without marking, and saving all the multiple documents in their category folder.

If the answer is NO at step 512, step 520 executes by revising the metadata of these multiple documents based on keywords contained therein so that they will not appear as having the same metadata again in a further search. Revising the metadata may be done automatically with processing device 130 by scanning the multiple documents to retrieve keywords from their contents, and by referring to a configurable look-up file at step 524. Alternatively, revising the metadata may be done manually by an administrator.

After the metadata is revised, the multiple documents with revised metadata will be saved in their respective category folder, as shown at step 522.

Back to step 514, after the duplicate document(s) is marked as “deleted,” step 516 executes by determining if all the documents have been categorized and saved. If the answer is NO, process 500 goes back to step 502 to process sequential imported documents. If the answer is YES, step 518 executes by deleting the documents marked as “deleted.”

The disclosed embodiments not only are applicable to new documents imported from a new customer, but also applicable to re-organizing uploaded documents and existing documents saved in system 100 for an existing customer.

FIG. 6 depicts a process 600 for reorganizing uploaded documents and existing documents for an existing customer of system 100. In the following descriptions of FIG. 6, some steps that have been previously discussed will be omitted for brevity.

Process 600 aims to reorganize existing documents saved in system 100 and new uploaded documents sent for the existing customer. Reorganizing the existing documents and managing the new uploaded documents may be performed at the same time or in different time. In the exemplary embodiment of FIG. 6, the existing documents and the new uploaded documents are categorized and organized together.

Steps 602 and 604 executes by uploading new documents and re-organizing existing documents.

Step 606 executes by analyzing metadata embedded in the uploaded documents and the existing documents.

Next, step 608 executes by determining whether the uploaded documents and the existing documents are categorizable based on an existing category map. If the answer for step 608 is NO, i.e., some documents are uncategorizable based on the existing category map, process 600 goes to step 610. Step 610 executes the categorization for the uncategorizable documents according to steps 416-426 discussed in FIG. 4.

If the answer of step 608 is Yes, step 612 next executes by determining if there are suitable folders for storing the uploaded documents and the existing documents that are categorizable. Please note that in most probable cases, some of the uploaded documents and the existing documents are uncategorizable and the rest of the uploaded documents and existing documents are categorizable. Therefore, at steps 608, the uncategorizable documents are sent to step 610 for additional categorization, and the categorizable documents are sent to 612 for further actions.

Therefore, if there are suitable folders in system 100 for the categorizable documents, step 616 executes by saving the categorizable documents to their respective folders. If suitable folders are not found for some or all of the categorizable documents, step 614 executes by generating new folders based on categories of those documents and step 618 executes by saving those documents in the new folders.

Next, step 620 executes by detecting if there are duplicated documents in the uploaded documents and the existing documents. If the answer is NO, process 600 goes to step 622 to end the process. However, if the answer is YES, step 624 executes by marking duplicated documents as “Deleted,”, and step 626 executes by deleting the documents marked as “Deleted.” Details of how to detect and delete the duplicated documents regarding steps 620-626 can be referred to the descriptions of steps 508-526 of FIG. 5.

Based on the above, the disclosed embodiments may automatically identify a destination folder for a document based on its embedded metadata. If the metadata of the document is not sufficient for categorization, the disclosed embodiments analyzes the document contextually with keywords to determine a suitable category for the document and save the document to a suitable folder. Further, the disclosed embodiments may identify and delete duplicate documents by comparing their metadata and contents. Therefore, the system and methods in accordance with of the disclosed embodiments can rapidly and efficiently import and organize a large number of files. The system and methods in accordance with the disclosed embodiments can also re-organize existing documents, identify duplicate documents and clean up folders so that a storage cost of the existing documents can be reduced.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof. Embodiments may be implemented as a computer process, a computing system or as an article of manufacture such as a computer program product of computer readable media.

The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A computer-implemented method for importing bulk documents from a legacy system to a new system, the method comprising:
scanning a plurality of documents using a scanning device, wherein the plurality of documents includes a number of pages;
uploading a plurality of electronic documents into a new electronic document management system having a file size based on the number of pages that is not storable in the legacy system;
analyzing the plurality of electronic documents to identify metadata embedded in each electronic document of the plurality of electronic documents, wherein the metadata includes electronic data specific to the respective electronic document;
determining whether the plurality of electronic documents is categorizable based on an existing category map;
if the plurality of electronic documents is categorizable, automatically categorizing the plurality of electronic documents based on the metadata embedded in the plurality of electronic documents;
automatically storing the plurality of electronic documents to their respective category folders based on the categories of the plurality of electronic documents; if no suitable folders are found for certain electronic documents among the plurality of electronic documents, generating new folders for saving the certain documents;
if the plurality of electronic documents is not categorizable, placing the plurality of documents in a miscellaneous folder;
analyzing contents of the plurality of electronic documents to obtain keywords of the plurality of electronic documents;
searching same keywords from a configurable look-up file; and
categorizing the plurality of electronic documents based on the same keywords found in the configurable look-up table.

2. The computer-implemented method of claim 1, wherein the metadata include information regarding titles, authors, generating dates, classes, and attributes of the electronic documents, and wherein the category folders are generated based on a categorization map, the categorization map is created based on existing folder structures, and a standard business folder structure.

3. The computer-implemented method of claim 2, further comprising revising the categorization map or creating a new categorization map if the categorization map is not sufficient to categorize the plurality of electronic documents.

4. (canceled)

5. (canceled)

6. The computer-implemented method of claim 1, further comprising detecting and deleting duplicate electronic documents while uploading the plurality of electronic documents.

7. The computer-implemented method of claim 6, further comprising detecting that two or more electronic documents among the plurality of electronic documents has same metadata, comparing contents of the two or more electronic documents to determine if the contents of the two or more electronic documents are exactly the same, reserving one electronic document from the two or more electronic documents, and marking a remaining of the two or more electronic documents as deleted.

8. The computer-implemented method of claim 7, further comprising deleting the remaining of the two or more electronic documents marked as deleted after all of the plurality of electronic documents are uploaded, categorized, and stored in the multiple folders.

9. The computer-implemented method of claim 2, further comprising creating a storage to store the category folders during uploading the plurality of electronic documents.

10. A computer-implemented method for organizing newly imported electronic documents and existing electronic documents saved in an electronic document management system, the method comprising:
scanning a plurality of documents using a scanning device, wherein the plurality of documents includes a number of pages;
uploading a plurality of electronic documents having a file size based on the number of pages that is not storable in the legacy system;
analyzing the plurality of electronic documents to identify metadata embedded in each electronic document of the plurality of electronic documents, wherein the metadata includes electronic data specific to the respective electronic document;
determining whether the plurality of electronic documents is categorizable based on an existing category map;
if the plurality of electronic documents is categorizable, categorizing the uploaded plurality of electronic documents and the existing electronic documents based on metadata embedded in the uploaded plurality of electronic documents and the existing electronic documents;
reorganizing existing folders of the electronic document management system, each of the existing folders corresponding to a category of the uploaded plurality of electronic documents and the existing electronic documents; and
storing the uploaded plurality of electronic documents and the existing electronic documents to the reorganized folders based on categories of the uploaded plurality of electronic documents and the existing electronic documents,
wherein reorganizing the existing folder includes one or both of revising the existing folders and creating new folders based on information stored in the metadata,
wherein the information stored in the metadata includes titles, authors, generating dates, classes and attributes of the uploaded plurality of electronic documents and the existing electronic documents;
if the plurality of electronic documents is not categorizable, placing the plurality of documents in a miscellaneous folder;
analyzing contents of the plurality of electronic documents to obtain keywords of the plurality of electronic documents;
searching same keywords from a configurable look-up file; and
categorizing the plurality of electronic documents based on the same keywords found in the configurable look-up table.

11. The computer-implemented method of claim 10, further comprising:
determining if there are duplicate electronic documents among the uploaded plurality of electronic documents and the existing electronic documents;
reserving one document among the duplicated electronic documents, and marking a remaining of the duplicated electronic documents as deleted; and
deleting the remaining of the duplicated electronic documents after all of the uploaded plurality of electronic documents and the existing electronic documents are saved.

12. The computer-implemented method of claim 11, wherein determining duplicated electronic documents comprises:
detecting two or more electronic documents among the uploaded plurality of electronic documents and the existing electronic documents having same metadata;
comparing contents of the two or more electronic documents; and
if the contents of the two or more electronic documents are exactly the same, reserving the one electronic document of the two or more electronic documents and marking the remaining of the two or more electronic documents as deleted.

13. (canceled)

14. (canceled)

15. An electronic document management system for organizing imported bulk electronic documents, the system comprising:
a database for storing medium-readable instructions;
a scanning device to scan a plurality of documents to generate the bulk electronic documents that are readable within the electronic document management system, wherein the plurality of documents includes a number of pages;
a managing device, comprising a processor, wherein the medium-readable instructions stored in the database, when executed, causes the processor to:
upload the bulk electronic documents having a file size based on the number of pages that is not storable in a legacy electronic document management system into the electronic document management system, wherein the bulk electronic documents are migrating from the legacy electronic document management system;
analyze the plurality of electronic documents to identify metadata embedded in each electronic document of the plurality of electronic documents, wherein the metadata includes electronic data specific to the respective electronic document;
determine whether the plurality of electronic documents is categorizable based on an existing category map;
if the bulk electronic documents is categorizable, categorize the bulk electronic documents based on metadata embedded in the bulk electronic documents;
generate multiple folders, each corresponding to a category of the bulk electronic documents;
store the bulk electronic documents to the multiple folders based on the categories of the bulk electronic documents;
if the bulk documents are not categorizable, place the bulk electronic documents in a miscellaneous folder;
analyze contents of the bulk electronic documents to obtain keywords of the bulk electronic documents;
search same keywords from a configurable look-up file; and
categorize the bulk electronic documents based on the same keywords found in the configurable look-up table and
a storage for storing the multiple folders.

16. The system of claim 15, wherein the process is further configured to create a categorization map based on results of the categorized bulk electronic documents wherein the categorization map includes structures of the multiple folders, document classes, and attributes, and the categorization map is used for categorizing new incoming electronic documents.

17. (canceled)

18. (canceled)

19. The system of claim 15, wherein the processor is further configured to detect that two or more electronic documents among the bulk electronic documents has same metadata, compare contents of the two or more electronic documents to determine if the contents of the two or more electronic documents are exactly the same, reserve one electronic document from the two or more electronic documents, and mark a remaining of the two or more electronic documents as deleted.

20. The system of claim 19, wherein the processor is further configured to delete the remaining of the two or more electronic documents marked as “Deleted” after all of the bulk electronic documents are uploaded, categorized, and stored in the multiple folders.
